(19) United States
(12) Patent Application Publication
(10) Pub. No.: US 2017/0353001 A1
(43) Pub. Date: Dec. 7, 2017

(54) TUNABLE LASER

(71) Applicant: FUJITSU LIMITED, Kawasaki-shi (JP)

(72) Inventor: Kazumasa Takabayashi, Atsugi (JP)

(73) Assignee: FUJITSU LIMITED, Kawasaki-shi (JP)

(21) Appl. No.: 15/602,224

(22) Filed: May 23, 2017

(30) Foreign Application Priority Data
Jun. 1, 2016 (JP) 2016-109903

(51) Int. Cl. H01S 3/10; H01S 3/08

(52) U.S. Cl. CPC H01S 3/1003; H01S 3/10015; H01S 3/08013; H01S 3/08059

(57) ABSTRACT

A tunable laser includes a semiconductor optical amplifier, a waveguide wavelength-tunable filter that forms the tunable laser with the semiconductor optical amplifier, an optical splitting mechanism set on a coupling optical waveguide that couples the wavelength-tunable filter and the semiconductor optical amplifier, a first optical splitter of a waveguide type that splits at least part of a light beam split by the optical splitting mechanism into two light beams, a first optical waveguide coupled to one output end of the first optical splitter, a second optical waveguide that is coupled to another output end of the first optical splitter and includes a delay waveguide, a 90° hybrid waveguide that includes two input ports to which an output light beam from the first optical waveguide and an output light beam from the second optical waveguide are input and four output ports that output four output light beams.

### CROSS-REFERENCE TO RELATED APPLICATION

This application is based upon and claims the benefit of priority of the prior Japanese Patent Application No. 2016-109903, filed on Jun. 1, 2016, the entire contents of which are incorporated herein by reference.

### FIELD

The embodiments discussed herein are related to a tunable laser and a small-size wavelength locker in a tunable laser used as a light source for optical communications.

### BACKGROUND

In recent years, mainly a tunable laser has been used as a light source of an optical communication system using wavelength multiplexing. In the tunable laser, a wavelength locker for precisely controlling the oscillation wavelength of the tunable laser is used.

FIG. 13 is a conceptual configuration diagram of a related-art wavelength locker. As illustrated in FIG. 13, the wavelength locker includes a beam splitter 202 that splits part of an output light beam of a tunable laser 201 and a beam splitter 203 that causes the split light beam to be further split into two light beams. Furthermore, the wavelength locker includes a photodiode 206 for monitoring the light intensity of one of the light beams split by the beam splitter 203 and a photodiode 205 that monitors the transmitted light intensity after passing through a periodic filter, typically an etalon 204, regarding the other of the light beams split by the beam splitter 203.

The ratio of the monitored values of an output S_{PD1} of the optical detector 206 and an output S_{PD2} of the optical detector 205 (S_{PD1}/S_{PD2}) represents the transmittance of the etalon 204 at the wavelength of the output light of the tunable laser 201. Therefore, it becomes possible to cause the oscillation wavelength of the tunable laser 201 to match a desired wavelength by obtaining the transmittance of the etalon 204 at the desired wavelength in advance and carrying out feedback control to cause S_{PD1}/S_{PD2} to correspond with the transmittance of the etalon 204 at the desired wavelength.

In the related-art wavelength multiplexing communication system, the wavelength of the tunable laser is used while being fixed to a wavelength grid with substantially equal interval defined in advance, for example, a grid with a 50-GHz interval defined in the international telecommunication union telecommunication standardization sector (ITU-T). In this case, as illustrated in FIG. 14, the period (free spectrum range (FSR)) of the etalon used for the wavelength locker is set to 50 GHz and the peak wavelength positions of the transmission spectrum of the etalon are set in such a manner that the ITU-T grid wavelengths correspond with vicinities of intermediate points between the peak and bottom of the transmission spectrum of the etalon. This may enhance the efficiency of change in the transmittance (=S_{PD1}/S_{PD2}) of the etalon with respect to wavelength change and may cause the oscillation wavelength of the tunable laser to precisely match the grid wavelength.

Conversely, if the grid wavelengths correspond with the peaks or bottoms of the transmission spectrum of the etalon, the change in S_{PD1}/S_{PD2} with respect to the wavelength becomes small. Thus, it is preferable to avoid the corresponding of the grid wavelengths with the bottoms or peaks.

As described above, in the wavelength locker, it is preferable to shift the grid wavelengths from the peak or bottom wavelengths of the etalon inside the wavelength locker by causing the FSR of the etalon to precisely match the grid interval and precisely adjusting the peak wavelength positions of the transmission spectrum of the etalon. This matching and adjustment may be implemented by precisely adjusting the thickness of the etalon, the angle of incidence of laser light to the etalon, and the temperature of the etalon. However, there is a problem that the adjustment takes high cost regarding each parameter.

Moreover, studies are being made on introduction of a flexible grid system based on the supposition that the grid interval is arbitrarily changed in the future. In this system, as illustrated in FIG. 15, the minimum grid interval is 6.25 GHz and it is conceivable that the grid interval is shorter than the FSR of the etalon. Thus, it becomes difficult to completely avoid the corresponding of the grid wavelengths with the peaks or bottoms of the etalon even when various kinds of adjustment of the etalon like the above-described ones are carried out.

Therefore, as a technique for avoiding the corresponding with the peak wavelength or bottom wavelength of the etalon with any wavelength, a wavelength locker using two etalons has been proposed. FIG. 16 is a conceptual configuration diagram of a related-art improved wavelength locker. The wavelength locker is obtained by adding a beam splitter 207, an etalon 208, and a photodiode 209 to the configuration illustrated in FIG. 13.

In this case, the ratio S_{PD1}/S_{PD3} of the output S_{PD1} of the optical detector 206 and an output S_{PD3} of the optical detector 209 is the monitored value of the transmittance of the etalon 204, and the ratio S_{PD2}/S_{PD3} of the output S_{PD2} of the optical detector 205 and the output S_{PD3} of the optical detector 209 is the monitored value of the transmittance of the etalon 208. In this case, as illustrated in FIG. 17, the FSRs of the two etalons 204 and 208 are identical to each other and are both 50 GHz, for example. In addition, the peak wavelengths of the transmission spectra of the etalons 204 and 208 are adjusted to be shifted from each other by ¼ of the FSR, i.e. 12.5 GHz.

As above, due to the use of the two etalons 204 and 208, the peak wavelength or bottom wavelength of one etalon 204 is not the peak wavelength or bottom wavelength in the other etalon 208. Therefore, by selecting which of the monitored values of the etalons 204 and 208 is to be used according to the target wavelength, it becomes possible to keep each wavelength from overlapping with the peak wavelengths or bottom wavelengths of the two etalons 204 and 208 simultaneously.

However, in the related-art method, because the FSRs of the etalon 204 and the etalon 208 are made to precisely correspond with each other and the peak wavelengths of the etalons 204 and 208 are precisely shifted from each other by ¼ of the FSR, the thickness, the angle of incidence, the temperature, and so forth of the two etalons 204 and 208 are precisely adjusted. Therefore, there is a problem that the cost taken for the adjustment increases even compared with the related-art configuration using one etalon, illustrated in FIG. 13.

Moreover, there is a problem that the size of the wavelength locker becomes larger due to the configuration using the two etalons. As described above, with the configurations of the related-art wavelength lockers, it is difficult to implement a wavelength locker capable of stable wavelength control with respect to an arbitrary wavelength with a small size and at low cost.

The followings are reference documents.

### [Document 1] Japanese Laid-open Patent Publication No. 2015-060961, and

[Document 2] Seok Hwan Jeong and Ken Morito,“Compact and wideband optical 90° hybrid based on a one-way tapered MMI coupler”, 2011 Optical Fiber Communication Conference and Exposition and the National Fiber Optic Engineers Conference, 6-11 Mar. 2011.

### SUMMARY

According to an aspect of the embodiments, a tunable laser includes a semiconductor optical amplifier, a waveguide wavelength-tunable filter that forms the tunable laser with the semiconductor optical amplifier, an optical splitting mechanism set on a coupling optical waveguide that couples the wavelength-tunable filter and the semiconductor optical amplifier, a first optical splitter of a waveguide type that splits at least part of a light beam split by the optical splitting mechanism into two light beams, a first optical waveguide coupled to one output end of the first optical splitter, a second optical waveguide that is coupled to another output end of the first optical splitter and includes a delay waveguide, a 90° hybrid waveguide that includes two input ports to which an output light beam from the first optical waveguide and an output light beam from the second optical waveguide are input and four output ports that output four output light beams; a first output waveguide and a second output waveguide coupled to two output ports that output at least light beams whose phases are shifted from each other by 90° among the four output ports; a first optical detector that receives an output light beam of the first output waveguide; and a second optical detector that receives an output light beam of the second output waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a conceptual configuration diagram of a tunable laser of an embodiment of the present disclosure;

FIG. 2 is an explanatory diagram of a transmission characteristic of a wavelength locker of a tunable laser of the embodiment of the present disclosure;

FIG. 3 is a conceptual configuration diagram of a tunable laser of embodiment example 1 of the present disclosure;

FIG. 4 is a sectional view of a major part of a wavelength-tunable filter used for a tunable laser of embodiment example 1 of the present disclosure;

FIG. 5 is a schematic sectional view of a semiconductor optical amplifier (SOA) used for a tunable laser of embodiment example 1 of the present disclosure;

FIG. 6 is an explanatory diagram of a monitored value of an output power of a tunable laser of embodiment example 1 of the present disclosure;

FIG. 7 is an explanatory diagram of monitored values of a wavelength locker of a tunable laser of embodiment example 1 of the present disclosure;

FIG. 8 is a schematic plan view of a 90° hybrid waveguide in a tunable laser of embodiment example 2 of the present disclosure;

FIG. 9 is a conceptual configuration diagram of a tunable laser of embodiment example 3 of the present disclosure;

FIG. 10 is a conceptual configuration diagram of a tunable laser of embodiment example 4 of the present disclosure;

FIG. 11 is a conceptual configuration diagram of a tunable laser of embodiment example 5 of the present disclosure;

FIG. 12 is a conceptual configuration diagram of an optical module of embodiment example 6 of the present disclosure;

FIG. 13 is a conceptual configuration diagram of a related-art wavelength locker;

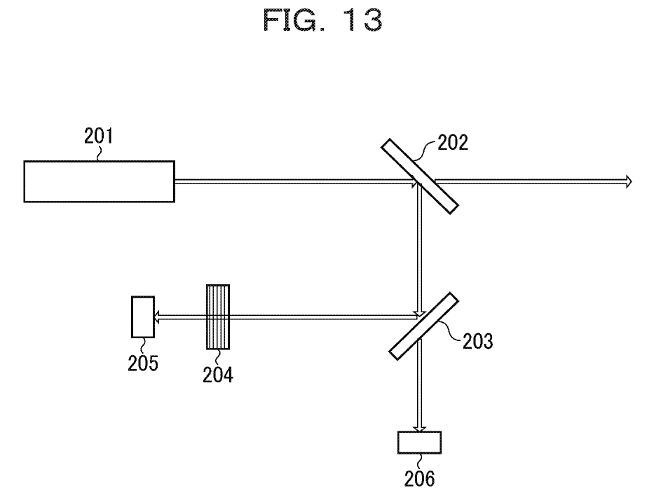

FIG. 14 is an explanatory diagram of a relationship between a monitored signal of a wavelength locker in a related-art wavelength locker and grid wavelengths;

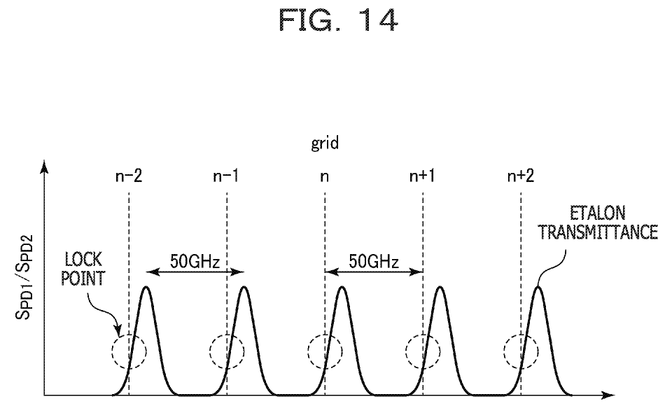

FIG. 15 is an explanatory diagram of a relationship between a monitored signal of a wavelength locker in a related-art wavelength locker and grid wavelengths in a flexible grid system;

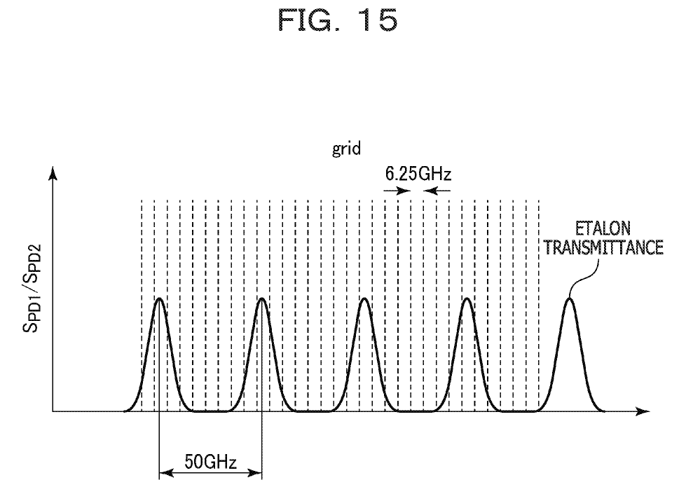

FIG. 16 is a conceptual configuration diagram of a related-art improved wavelength locker; and

FIG. 17 is an explanatory diagram of a relationship between monitored signals of a wavelength locker in a related-art improved wavelength locker and grid wavelengths.

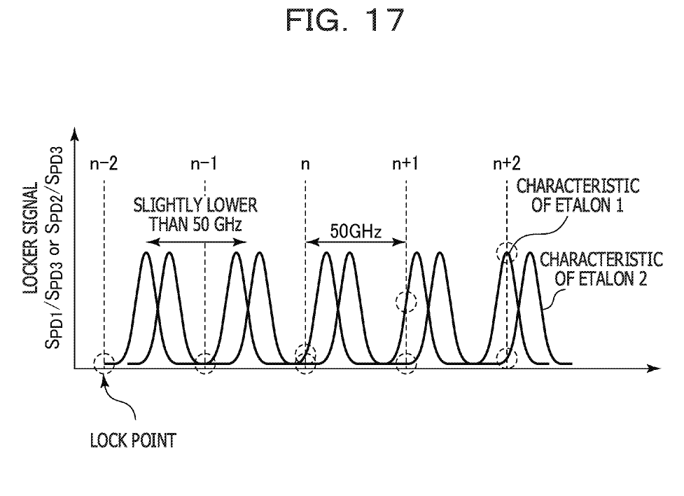

### DESCRIPTION OF EMBODIMENTS

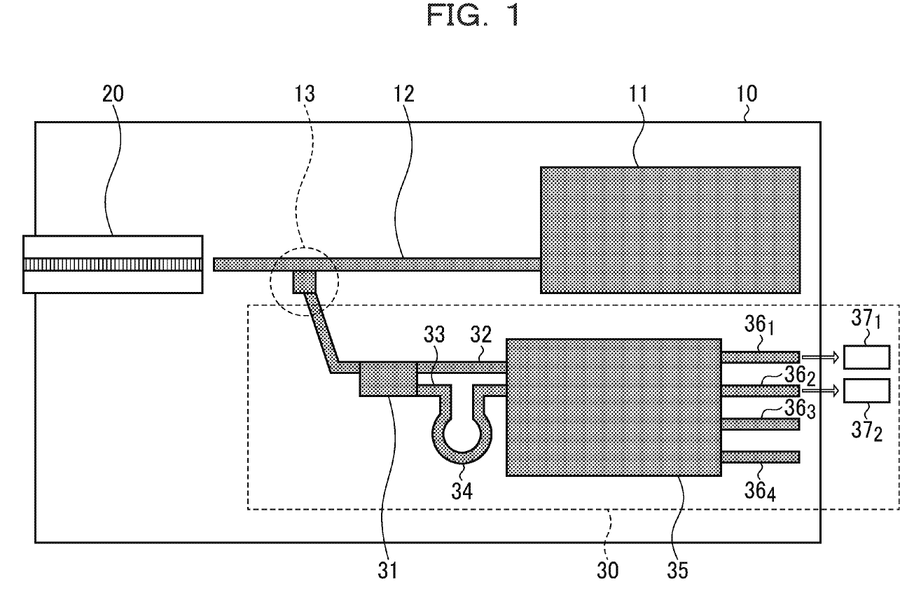

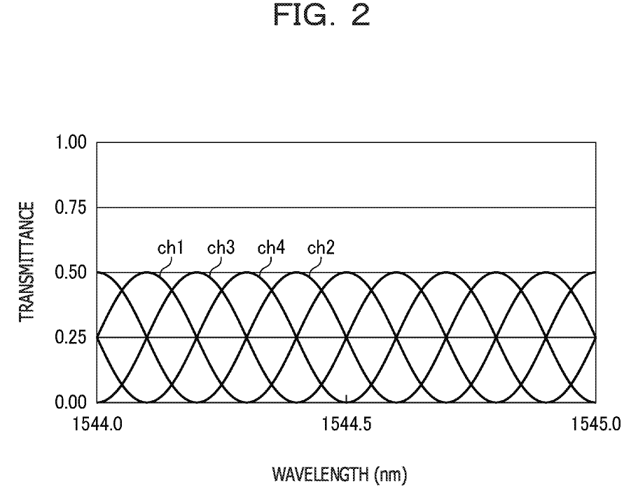

A tunable laser of an embodiment of the present disclosure will be described with reference to FIG. 1 and FIG. 2. FIG. 1 is a conceptual configuration diagram of a tunable laser of the embodiment of the present disclosure. The tunable laser of the present disclosure includes a semiconductor optical amplifier 20, a waveguide wavelength-tunable filter 11 that forms the tunable laser with the semiconductor optical amplifier 20, and a wavelength locker 30. An optical splitting mechanism 13 that splits part of light in a laser resonator including the wavelength-tunable filter 11 and the semiconductor optical amplifier 20 is provided and at least part of the light split by the optical splitting mechanism 13 is guided to the wavelength locker 30. It is to be noted that numeral 12 denotes an optical waveguide that couples the wavelength-tunable filter 11 and the semiconductor optical amplifier 20.

The wavelength locker 30 includes a first optical splitter 31 of a waveguide type, a first optical waveguide 32 coupled to one output end of the first optical splitter 31, a second optical waveguide 33 that is coupled to the other output end of the first optical splitter 31 and includes a delay waveguide 34, and a 90° hybrid waveguide 35 including two input ports and four output ports. The wavelength locker 30 includes a first output waveguide 36₁ and a second output waveguide 36₂ coupled to two output ports that output at least light beams whose phases are shifted from each other by 90° among the four output ports of the 90° hybrid waveguide 35. The first output waveguide 36₁ and the second output waveguide 36₂ are coupled to a first optical detector 37₁ and a second optical detector 37₂, respectively.

In this case, it is desirable to at least monolithically integrate the wavelength-tunable filter 11, the optical splitting mechanism 13, the first optical splitter 31, the first optical waveguide 32, the second optical waveguide 33 including the delay waveguide 34, the 90° hybrid waveguide 35, the first output waveguide 36₁, and the second output waveguide 36₂.

For example, the wavelength-tunable filter 11 may be a vernier-type wavelength-tunable filter including three straight-line optical waveguides that are juxtaposed, two ring resonators disposed one by one among the three optical waveguides, and a loop mirror provided at an end part of the optical waveguide remotest from the semiconductor optical amplifier 20 among the three optical waveguides. Alternatively, a vernier-type wavelength-tunable filter including a sampled grating distributed Bragg reflector may be used. The sampled grating distributed Bragg reflector includes two distributed Bragg reflectors whose periods are different from each other. Effects of the present disclosure are similarly achieved with any waveguide wavelength-tunable filter.

The 90° hybrid waveguide 35 may be a 4×4 multimode interference waveguide or may be a multimode interference waveguide with a two-stage configuration obtained by coupling four 2×2 multimode interference waveguides.

As the optical splitting mechanism 13, any of a directional coupler, a multimode interferometer, and a Y-branch waveguide may be used. Alternatively, the optical splitting mechanism 13 may be formed of a partial reflection mechanism in which a loop mirror is used for partial reflection and an optical waveguide that propagates a light beam that is not reflected by the partial reflection mechanism. Furthermore, the first optical splitter 31 may be any of a directional coupler, a multimode interferometer, and a Y-branch waveguide.

For size reduction, it is desirable to form at least the waveguide wavelength-tunable filter 11, the first optical waveguide 32, the second optical waveguide 33, the delay waveguide 34, the first output waveguide 36₁, and the second output waveguide 36₂ by silicon wire waveguides by using a Si waveguide substrate having a silicon on insulator (SOI) structure as a substrate 10. In this case, it is also possible to mount the semiconductor optical amplifier 20 in a recess part made in the substrate 10.

Moreover, for size reduction, as the first optical detector 37₁ and the second optical detector 37₂, photodiodes that include a Ge layer and are monolithically integrated on silicon wire waveguides serving as the first output waveguide 36₁ and the second output waveguide 36₂, respectively, may be used.

Alternatively, a compound semiconductor waveguide may be used as the waveguide wavelength-tunable filter 11. In this case, the wavelength-tunable filter 11 may be monolithically integrated with the semiconductor optical amplifier 20. Therefore, size reduction of the whole device is possible and an assembly for establishing optical coupling from the tunable laser to the wavelength locker 30 becomes unnecessary. Moreover, the wavelength-tunable filter 11 or the wavelength locker 30 may be formed of a quartz waveguide.

Moreover, a second optical splitter of a waveguide type that splits the light beam split by the optical splitting mechanism 13 into two light beams may be further provided at the previous stage of the first optical splitter 31. Furthermore, a third optical detector that receives a light beam other than the light beam split to the first optical splitter 31 may be provided and a power monitoring mechanism may be added.

In this case, a first monitoring mechanism that takes the ratio of monitored values of the first optical detector 37₁ and the third optical detector and a second monitoring mechanism that takes the ratio of monitored values of the second optical detector 37₂ and the third optical detector are provided. To control the wavelength, it is desirable to provide a wavelength control mechanism that controls the oscillation wavelength of the tunable laser in such a manner that the ratio of the monitored value of the first monitoring mechanism and the monitored value of the second monitoring mechanism becomes a prescribed value. As the wavelength control mechanism in this case, a mechanism that causes a current to flow to a heater provided on the waveguide that forms the waveguide wavelength-tunable filter 11 may be used.

Alternatively, the power monitoring mechanism may be a mechanism that adds an output light beam from one output port of the 90° hybrid waveguide 35 and an output light beam from the output port at which the phase is shifted from the output light beam from the one output port by 180° among the four output ports of the 90° hybrid waveguide 35. Alternatively, a power monitoring mechanism that monitors part of an output light beam from the semiconductor optical amplifier 20 may be employed.

FIG. 2 is an explanatory diagram of a transmission characteristic of a wavelength locker of a tunable laser of the embodiment of the present disclosure. In the waveguide obtained by combining the delay waveguide 34 and the 90° hybrid waveguide 35, transmission spectra having a sine wave shape with a period according to the delay amount of the delay waveguide 34 are obtained with respect to the wavelength at the four output ports of the 90° hybrid waveguide 35. The spectra whose period is the same among the four output ports and whose transmission peak wavelengths are shifted from each other by every ¼ of the period among the four output ports are obtained.

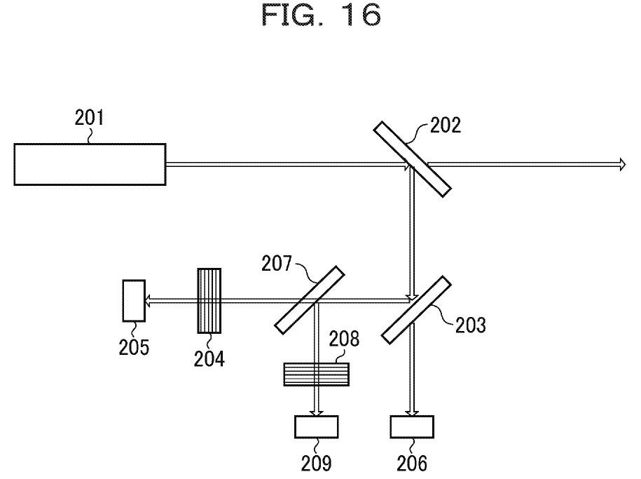

The reason why the period is the same among the four output ports is because the same delay waveguide 34 is used. Furthermore, the relationship in which the peak positions are shifted from each other by every ¼ period among the four output ports is a characteristic ensured because the phases at the respective output ports of the 90° hybrid waveguide 35 are shifted from each other by every n/2. Therefore, adjustment to cause the FSRs to correspond with each other, which is carried out in the related-art case using two etalons, illustrated in FIG. 16, and adjustment to shift the peak wavelengths from each other by every ¼ period are unnecessary, which may reduce the adjustment cost.

It is to be noted that a supposition will be made about the case in which two individual periodic wavelength filters include waveguide filters, for example, the case in which the wavelength filters include two ring resonator waveguides, similarly to the case of using the etalons of the related-art example. In this case, similarly to the case of the etalons of the related-art example, adjustment of the FSRs and peak positions of the two wavelength filters is carried out and it is difficult to automatically obtain the relationship in which the peak positions are shifted by the ¼ period as in the present disclosure. Therefore, adjustment of the peak wavelength positions is carried out and it is difficult to realize the reduction in the cost taken for the adjustment of the peak positions, which is an issue of the related art.

### Embodiment Example 1

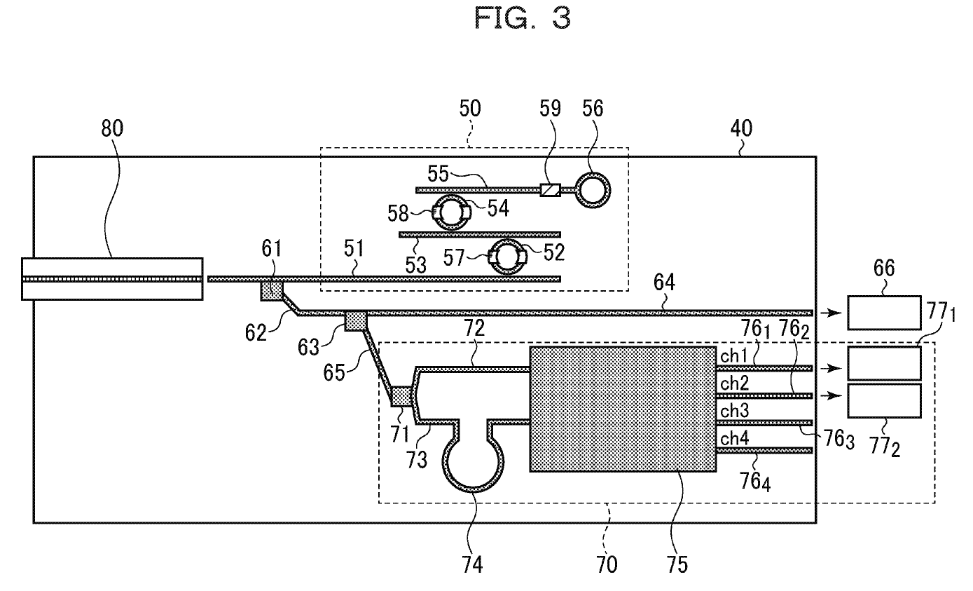

Next, a tunable laser of embodiment example 1 of the present disclosure will be described with reference to FIG. 3 to FIG. 7. FIG. 3 is a conceptual configuration diagram of a tunable laser of embodiment example 1 of the present disclosure. The major part of the tunable laser is formed of a Si waveguide substrate 40 and an SOA 80 including a multi-quantum well (MQW) active layer serving as a gain waveguide. In the Si waveguide substrate 40, a wavelength-tunable filter 50 and a wavelength locker 70 are provided. It is to be noted that the SOA 80 is mounted in a recess part made in the Si waveguide substrate 40.

The wavelength-tunable filter 50 includes three straight-line optical waveguides 51, 53, and 55 based on Si wire waveguides, a loop mirror 56 as a total reflection mirror, and two ring resonators 52 and 54 different in the radius of curvature for obtaining the Vernier effect of selecting the wavelength. The optical waveguide 51 coupled to the SOA 80 is provided with a directional coupler 61 as an optical splitting mechanism and the directional coupler 61 guides split light to a directional coupler 63 through an optical waveguide 62.

Furthermore, the two ring resonators 52 and 54 are provided with heaters 57 and 58 in order to change the refractive index and shift the resonance wavelength of the ring resonator to carry out wavelength tuning. A phase adjustment heater 59 is provided immediately before the loop mirror 56 of the optical waveguide 55 and these heaters are coupled to a drive electronic circuit separately disposed in the module through the element surface.

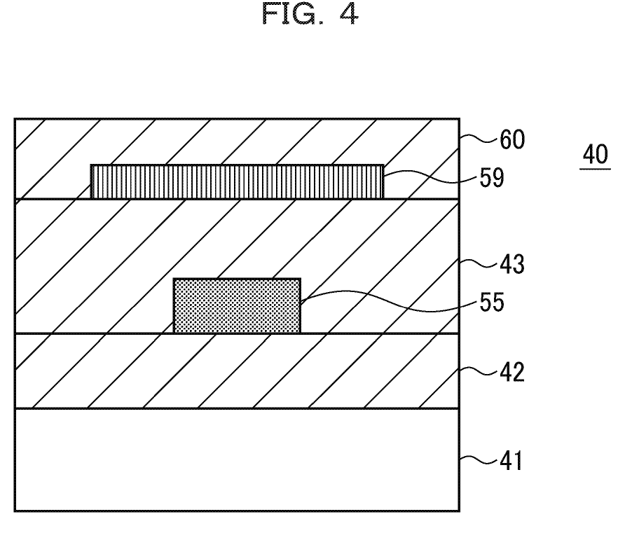

FIG. 4 is a sectional view of a major part of a wavelength-tunable filter used for a tunable laser of embodiment example 1 of the present disclosure and is illustrated as a sectional view of the optical waveguide 55 here. The Si wire waveguide is formed by utilizing an SOI substrate and is formed by etching a single-crystal Si layer provided over a single-crystal Si substrate 41 with the intermediary of a BOX layer 42 that doubles as a lower clad layer. The Si wire waveguide is formed of a Si core layer whose sectional shape has a width of 500 nm and a thickness of 250 nm and has a shape surrounded by a SiO₂ upper clad layer 43. Furthermore, the heaters such as the phase adjustment heater 59 are formed by patterning Ti deposited on the SiO₂ upper clad layer 43 and are covered by a SiO₂ protective film 60.

The laser resonator is formed between a cleavage end surface of the SOA 80 and the loop mirror 56 of the wavelength-tunable filter 50. The ring resonators 52 and 54 have periods of resonance wavelength (FSRs) minutely different from each other, for example, the FSR of one of the two ring resonators 52 and 54 is 5 nm and the other is 5.5 nm. The ring resonators 52 and 54 form a vernier-type wavelength-tunable filter that selects one wavelength based on the overlapping of the resonance wavelengths of the two ring resonators. A tunable laser that carries out laser oscillation at an arbitrary wavelength may be implemented by arbitrarily setting the wavelength at which the resonance wavelengths of the two ring resonators 52 and 54 overlap and making a combination with the SOA 80.

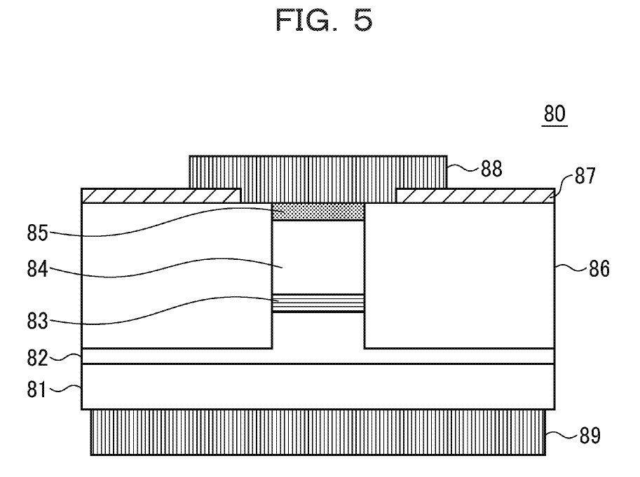

FIG. 5 is a schematic sectional view of an SOA used for a tunable laser of embodiment example 1 of the present disclosure. Over an n-type InP substrate 81, an n-type InP clad layer 82, an MQW active layer 83, a p-type InP clad layer 84, and a p-type InGaAs contact layer 85 are sequentially deposited. Subsequently, part of the layers from the p-type InGaAs contact layer 85 to the n-type InP clad layer 82 is etched in a stripe manner to form a mesa structure and this stripe-manner mesa structure is buried by a Fe-doped InP buried layer 86. An n-side electrode 89 is formed on the back surface of the n-type InP substrate 81 and a p-side electrode 88 is provided on the p-type InGaAs contact layer 85 through a stripe-manner opening made in an SiO₂ film 87. As the MQW active layer 83, GaInAsP well layers whose thickness of six layers is 5.1 nm and GaInAsP barrier layers whose thickness of seven layers is 10 nm are alternately stacked and formed, for example.

The end surface on the side coupled to the optical waveguide 51 is supplied with an anti-reflection coating. At the other end surface, a cleavage surface or a reflective film having certain reflectance is formed. The end surface of the side on which the cleavage surface or the reflective film having certain reflectance is formed functions as a one-side reflective mirror that forms a resonator of a laser with the loop mirror 56.

It is to be noted that, in FIG. 5, the stripe-manner mesa structure is formed into a straight line shape. However, the stripe-manner mesa structure may be formed of an inclined waveguide having an angle of 7° with respect to the normal to the end surface, a bent waveguide, and a straight-line waveguide from the side of receiving light of the optical waveguide 51, and undesired reflection may be reduced. At this time, the end part side of the optical waveguide 51 is also inclined in conformity to the inclined waveguide so that the angle of departure may match the angle of the inclined waveguide.

Referring to FIG. 3 again, one light beam split by the directional coupler 63 is guided to a photodiode 66 via an optical waveguide 64. The other light beam split by the directional coupler 63 is guided to the wavelength locker 70 via an optical waveguide 65.

The wavelength locker 70 includes a directional coupler 71, an optical waveguide 72, an optical waveguide 73 including a delay waveguide 74 in which the delay amount is approximately 1.4 mm, and a 90° hybrid waveguide 75 including a 4×4 multimode interference (MMI) waveguide that couples the optical waveguides 72 and 73 to first and third input ports and includes four output ports. Output waveguides 76₁ to 76₄ are coupled to the respective output ports of the 90° hybrid waveguide 75 and two output waveguides 76₁ and 76₂ that output light beams whose phases are shifted from each other by 90° are guided to photodiodes 77₁ and 77₂, respectively. It is to be noted that, instead of the directional couplers 61, 63, and 71, 1×2 MMI waveguides or Y-branch waveguides may be used.

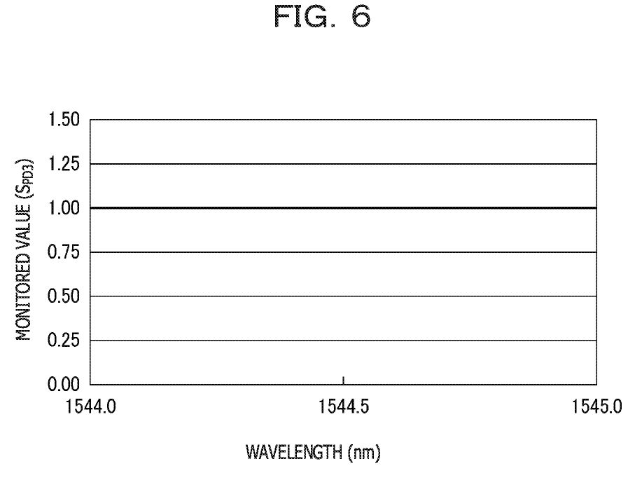

FIG. 6 is an explanatory diagram of a monitored value of an output power of a tunable laser of embodiment example 1 of the present disclosure. The photodiode 66 is used as a simple power monitor for directly monitoring part of light split from the inside of the resonator. As illustrated in FIG. 6, the output power is almost steady with respect to the wavelength as long as there is no fluctuation due to temperature change or the like.

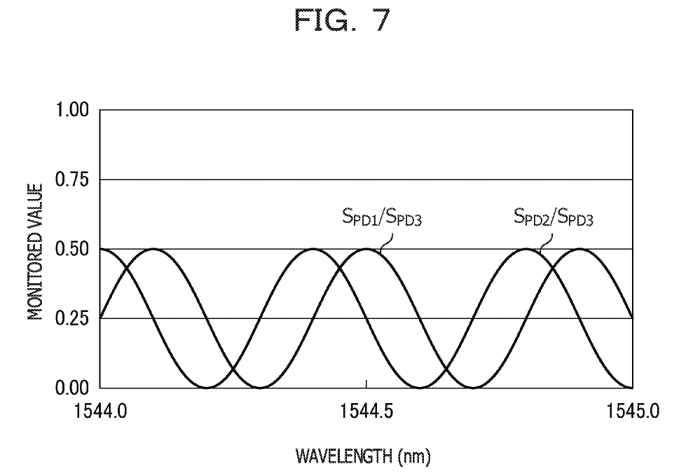

FIG. 7 is an explanatory diagram of monitored values of a wavelength locker of a tunable laser of embodiment example 1 of the present disclosure. Because the photodiodes 77₁ and 77₂ receive light that has passed through the delay waveguide 74 and the 90° hybrid waveguide 75, transmission characteristics that are periodic with respect to the wavelength are obtained. The period depends on the delay amount of the delay waveguide 74 and is approximately 0.4 nm (=50 GHz). At the first and second output ports of the 90° hybrid waveguide 75, the light beams incident from the optical waveguides 72 and 73 are coupled with the phases shifted from each other by n/2. This provides the relationship in which the transmission peak wavelengths are shifted from each other by ¼ of the period as illustrated in FIG. 7. This makes it possible to realize the relationship in which the periods with respect to the wavelength are the same and the peak wavelengths are shifted by ¼ of the period as two wavelength locker outputs, only by fabrication of Si waveguides without fine adjustment.

It is to be noted that, in FIG. 7, the monitored values of the two photodiodes 77₁ and 77₂ are divided by the monitored value of the photodiode 66, which serves as a simple optical output monitor. For example, S_{PD1}/S_{PD3} and S_{PD2}/S_{PD3} are calculated. This enables conversion into the transmittance of the wavelength locker waveguide similarly to the related-art wavelength locker and makes it possible to control the wavelength without being affected by overall increase and decrease in the intensity of light split into the wavelength locker 70 due to increase and decrease in the laser output power.

In embodiment example 1 of the present disclosure, by using the wavelength locker mechanism formed of Si waveguides, it becomes possible to implement two monitors of the wavelength locker having the same period with respect to the wavelength and having peak wavelengths shifted by the ¼ period without carrying out precise adjustment. Therefore, it becomes possible to implement, at low cost, the wavelength locker mechanism for properly selecting the two monitors according to the target wavelength and keeping the target wavelength from corresponding with the peak or bottom of the monitor output.

Furthermore, the wavelength locker mechanism of the present disclosure is monolithically integrated with a waveguide wavelength-tunable filter and thus it is also possible to reduce the size compared with the related-art configurations using an etalon or the like. It is to be noted that, in embodiment example 1, the position at which light from the laser resonator is split to the wavelength locker 70 is set near the coupling part with the SOA 80 and light in the direction from the SOA 80 toward the ring resonator 52 is split. However, the position of the splitting does not have to be this position. However, if light is split at this position and with this direction, a more desirable configuration is obtained because there is an advantage that the light may be split from the part at which the light intensity is the highest in the resonator due to optical amplification in the SOA 80 and thus the light may be efficiently supplied to the wavelength locker 70.

### Embodiment Example 2

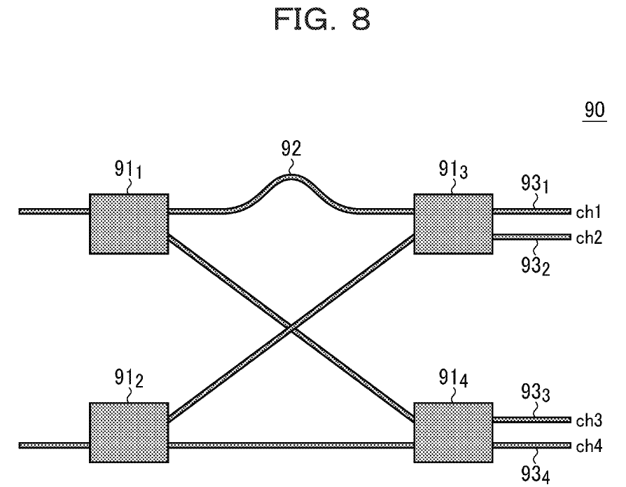

Next, a tunable laser of embodiment example 2 of the present disclosure will be described with reference to FIG. 8. The tunable laser of embodiment example 2 is obtained by replacing the 90° hybrid waveguide 75 in the tunable laser of embodiment example 1 of the present disclosure illustrated in FIG. 3 by a different 90° hybrid waveguide 90. Therefore, only the structure of the 90° hybrid waveguide 90 will be described here.

FIG. 8 is a schematic plan view of a 90° hybrid waveguide in a tunable laser of embodiment example 2 of the present disclosure. The 90° hybrid waveguide 90 is obtained by arranging four 2×2 MMI waveguides 91₁ to 91₄ into a two-stage configuration with the intermediary of a 90° phase shifter 92, and four outputs ch₁ to ch₄ represented in FIG. 2 are obtained from four output ports 93₁ to 93₄ of two 2×2 MMI waveguides 91₃ and 91₄ at the latter stage.

### Embodiment Example 3

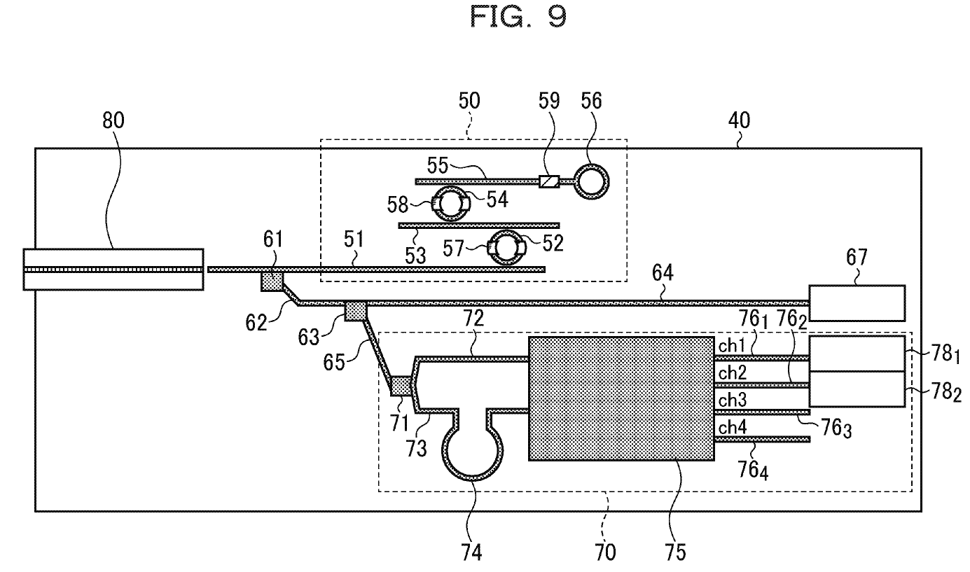

Next, a tunable laser of embodiment example 3 of the present disclosure will be described with reference to FIG. 9. The tunable laser of embodiment example 3 is obtained by replacing the photodiodes 66, 77₁, and 77₂ in the tunable laser of embodiment example 1 illustrated in FIG. 3 by Ge photodiodes 67, 78₁, and 78₂ that are monolithically integrated. FIG. 9 is a conceptual configuration diagram of a tunable laser of embodiment example 3 of the present disclosure and the basic configuration is similar to the above-described embodiment example 1.

In the embodiment example 3, the width of the single crystal silicon layer on the output end side of the optical waveguide 64 and the output waveguides 76₁ and 76₂ formed of Si wire waveguides is extended and a Ge layer is epitaxially grown thereon to form the p-i-n-type Ge photodiodes 67, 78₁, and 78₂.

In embodiment example 3 of the present disclosure, because the photodiodes are also formed on Si waveguides, it becomes possible to further reduce the size of the tunable laser including the wavelength locker. It is to be noted that, also in the embodiment example 3, the 90° hybrid waveguide 90 illustrated in FIG. 8 may be used.

### Embodiment Example 4

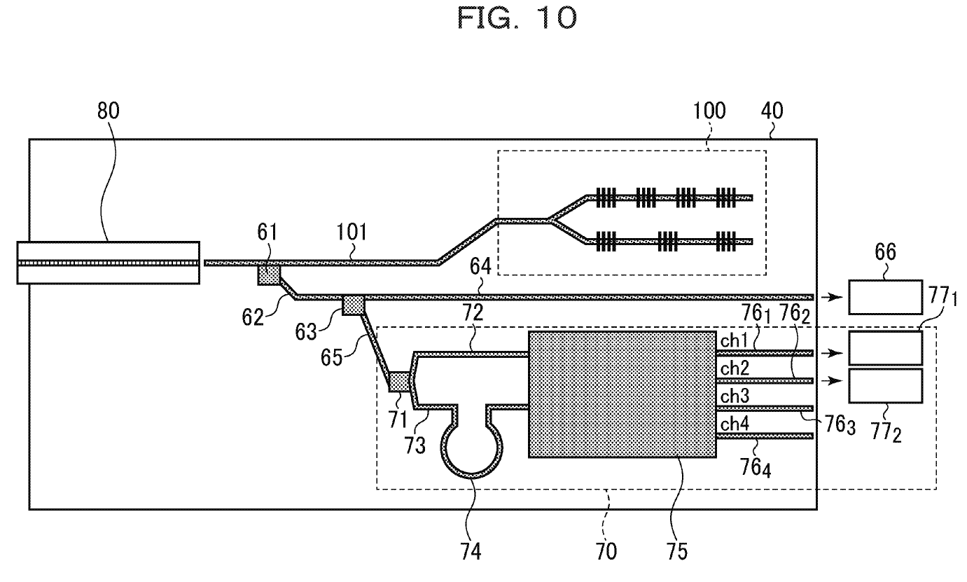

Next, a tunable laser of embodiment example 4 of the present disclosure will be described with reference to FIG. 10. The tunable laser of embodiment example 4 is obtained by replacing the wavelength-tunable filter 50 in the tunable laser of embodiment example 1 illustrated in FIG. 3 by a Y-branch sampled grating distributed Bragg reflector (SG-DBR). FIG. 10 is a conceptual configuration diagram of a tunable laser of embodiment example 4 of the present disclosure and the basic configuration is similar to the above-described embodiment example 1.

In the embodiment example 4, as a wavelength-tunable filter, a Y-branch SG-DBR 100 formed of a branch waveguide including two distributed Bragg reflectors whose periods are different from each other is used. Also in this configuration, the directional coupler 61 is provided close to the SOA 80 on an optical waveguide 101 that couples the Y-branch SG-DBR 100 and the SOA 80.

Similar effects to embodiment example 1 may be expected also in the configuration using the Y-branch SG-DBR as in embodiment example 4 of the present disclosure. It is to be noted that, also in the embodiment example 4, the 90° hybrid waveguide 90 illustrated in FIG. 8 may be used and the Ge photodiodes 67, 78₁, and 78₂ illustrated in FIG. 9 may be used.

### Embodiment Example 5

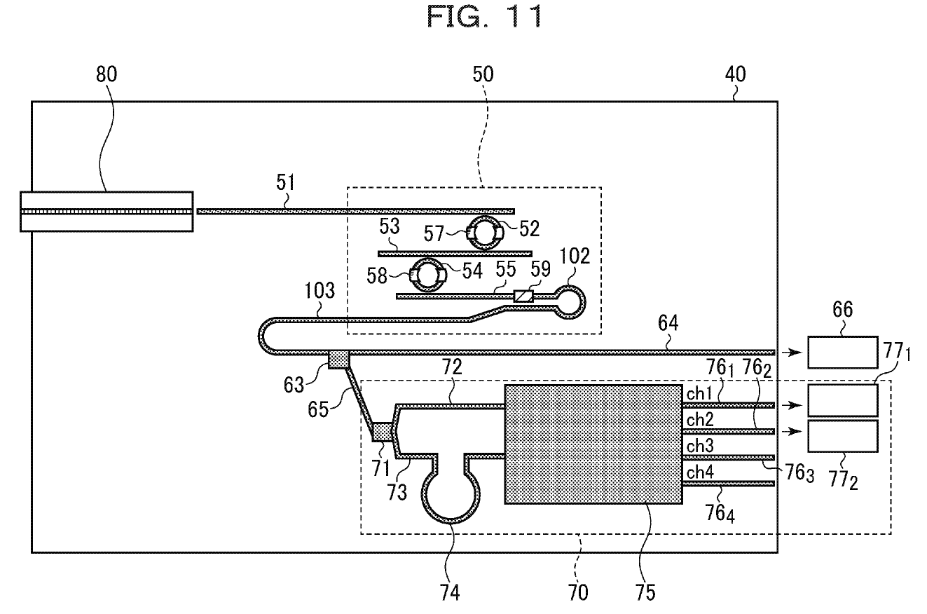

Next, a tunable laser of embodiment example 5 of the present disclosure will be described with reference to FIG. 11. The tunable laser of embodiment example 5 is obtained by replacing the loop mirror 56 in the tunable laser of embodiment example 1 illustrated in FIG. 3 by a partial reflection loop mirror. FIG. 11 is a conceptual configuration diagram of a tunable laser of embodiment example 5 of the present disclosure and the basic configuration is similar to the above-described embodiment example 1.

In the embodiment example 5, a partial reflection loop mirror 102 is used as a loop mirror that forms the wavelength-tunable filter and the placement of the optical waveguides 51, 53, and 55 and the ring resonators 52 and 54 are inverted. Furthermore, the partial reflection loop mirror 102 is provided with an optical waveguide 103. Here, light that is not reflected by the partial reflection loop mirror 102 and propagates into the optical waveguide 103 is guided to the directional coupler 63.

In embodiment example 5 of the present disclosure, because the wavelength-tunable filter is formed by using the partial reflection loop mirror 102, one directional coupler (61) becomes unnecessary. It is to be noted that, also in the embodiment example 5, the 90° hybrid waveguide 90 illustrated in FIG. 8 may be used and the Ge photodiodes 67, 78₁, and 78₂ illustrated in FIG. 9 may be used.

### Embodiment Example 6

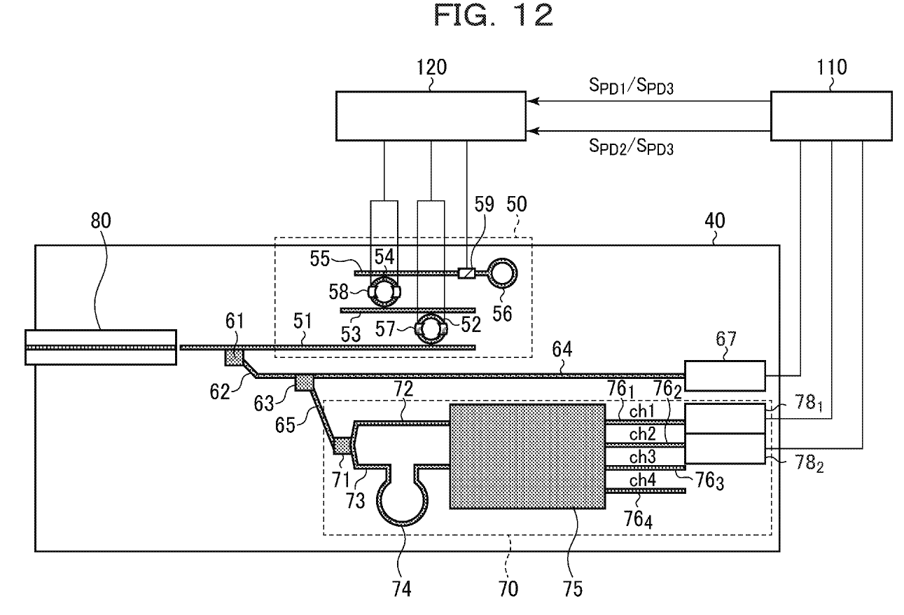

Next, an optical module of embodiment example 6 of the present disclosure will be described with reference to FIG. 12. The optical module of embodiment example 6 is obtained by providing the tunable laser of embodiment example 1 illustrated in FIG. 3 with a monitoring mechanism and a wavelength control mechanism. FIG. 12 is a conceptual configuration diagram of an optical module of embodiment example 6 of the present disclosure and the basic configuration is similar to the above-described embodiment example 1.

In the optical module of the embodiment example 6, by a monitoring mechanism 110, the ratio of the monitored values of the photodiode 66 and the photodiode 77₁ (S_{PD1}/S_{PD3}) and the ratio of the monitored values of the photodiode 66 and the photodiode 77₂ (S_{PD2}/S_{PD3}) are calculated. Based on these monitored values, by a wavelength control mechanism 120, the values of currents to the heaters 57 and 58 on the ring resonators 52 and 54 configuring the wavelength-tunable filter 50 and the phase adjustment heater 59 are controlled to control the resonance wavelengths of the ring resonators 52 and 54.

Conversion into the transmittance of the wavelength locker is enabled by taking the ratios of the monitored values in this manner, and laser oscillation with a desired wavelength is enabled by controlling the oscillation wavelength in such a manner that these transmittances become prescribed steady values. It is to be noted that, which monitored value ratio of S_{PD1}/S_{PD3} and S_{PD2}/S_{PD3} is to be employed is selected at each wavelength grid as the target wavelength. In this case, the wavelength dependence of the monitored value ratios of S_{PD2}/S_{PD3} and S_{PD2}/S_{PD3} is obtained in advance and, based on the result, the monitored value ratio with which the target wavelength does not correspond with the peak or bottom wavelength is selected. Due to this, with any wavelength, wavelength control is allowed in the state in which the target wavelength does not correspond with the peak or bottom of the monitored value ratio. Thus, stable wavelength control is allowed with an arbitrary wavelength.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A tunable laser comprising:
a semiconductor optical amplifier;
a waveguide wavelength-tunable filter that forms the tunable laser with the semiconductor optical amplifier;
an optical splitting mechanism set on a coupling optical waveguide that couples the wavelength-tunable filter and the semiconductor optical amplifier;
a first optical splitter of a waveguide type that splits at least part of a light beam split by the optical splitting mechanism into two light beams;
a first optical waveguide coupled to one output end of the first optical splitter;
a second optical waveguide that is coupled to another output end of the first optical splitter and includes a delay waveguide;
a 90° hybrid waveguide that includes two input ports to which an output light beam from the first optical waveguide and an output light beam from the second optical waveguide are input and four output ports that output four output light beams;
a first output waveguide and a second output waveguide coupled to two output ports that output at least light beams whose phases are shifted from each other by 90° among the four output ports;
a first optical detector that receives an output light beam of the first output waveguide; and
a second optical detector that receives an output light beam of the second output waveguide.

2. The tunable laser according to claim 1, wherein
the wavelength-tunable filter, the optical splitting mechanism, the first optical splitter, the first optical waveguide, the second optical waveguide including the delay waveguide, the 90° hybrid waveguide, the first output waveguide, and the second output waveguide are at least monolithically integrated.

3. The tunable laser according to claim 1, wherein
the wavelength-tunable filter is either a vernier-type wavelength-tunable filter formed of two ring resonators and a loop mirror or a vernier-type wavelength-tunable filter formed of a sampled grating distributed Bragg reflector including two distributed Bragg reflectors whose periods are different from each other.

4. The tunable laser according to claim 1, wherein
the 90° hybrid waveguide is either a 4×4 multimode interference waveguide or a multimode interference waveguide with a two-stage configuration obtained by coupling four 2×2 multimode interference waveguides.

5. The tunable laser according to claim 1, wherein
the optical splitting mechanism is any of a directional coupler, a multimode interferometer, and a Y-branch waveguide.

6. The tunable laser according to claim 1, wherein
the optical splitting mechanism is formed of a partial reflection mechanism in which a loop mirror is used for partial reflection and an optical waveguide that propagates a light beam that is not reflected by the partial reflection mechanism.

7. The tunable laser according to claim 1, wherein
the first optical splitter is any of a directional coupler, a multimode interferometer, and a Y-branch waveguide.

8. The tunable laser according to claim 1, wherein
at least the waveguide wavelength-tunable filter, the first optical waveguide, the second optical waveguide, the delay waveguide, the first output waveguide, and the second output waveguide are formed of silicon wire waveguides.

9. The tunable laser according to claim 8, wherein
the first optical detector and the second optical detector are photodiodes that include a Ge layer and are monolithically integrated on the silicon wire waveguides serving as the first output waveguide and the second output waveguide individually.

10. The tunable laser according to claim 1, wherein
the waveguide wavelength-tunable filter is formed of a compound semiconductor waveguide and is integrated monolithically with the semiconductor optical amplifier.

11. The tunable laser according to claim 1, wherein
the tunable laser includes a mechanism that adds an output light beam from one output port of the 90° hybrid waveguide and an output light beam from an output port at which a phase is shifted from the output light beam from the one output port by 180° among the four output ports of the 90° hybrid waveguide and uses an addition result for power monitoring.

12. The tunable laser according to claim 1, wherein
the tunable laser includes a power monitoring mechanism that monitors part of an output light beam from the semiconductor optical amplifier.

13. The tunable laser according to claim 1, further comprising:
a second optical splitter of a waveguide type that is set at a previous stage of the first optical splitter and splits the light beam split by the optical splitting mechanism into two light beams; and
a third optical detector that receives a light beam other than the light beam split to the first optical splitter.

14. The tunable laser according to claim 13, wherein
the second optical splitter is any of a directional coupler, a multimode interferometer, and a Y-branch waveguide.

15. An optical module comprising:
a semiconductor optical amplifier;
a waveguide wavelength-tunable filter that forms the tunable laser with the semiconductor optical amplifier;
an optical splitting mechanism set on a coupling optical waveguide that couples the wavelength-tunable filter and the semiconductor optical amplifier;
a first optical splitter of a waveguide type that splits at least part of a light beam split by the optical splitting mechanism into two light beams;
a first optical waveguide coupled to one output end of the first optical splitter;
a second optical waveguide that is coupled to another output end of the first optical splitter and includes a delay waveguide;
a 90° hybrid waveguide that includes two input ports to which an output light beam from the first optical waveguide and an output light beam from the second optical waveguide are input and four output ports that output four output light beams;
a first output waveguide and a second output waveguide coupled to two output ports that output at least light beams whose phases are shifted from each other by 90° among the four output ports;
a first optical detector that receives an output light beam of the first output waveguide;
a second optical detector that receives an output light beam of the second output waveguide;
a first monitoring mechanism that takes a ratio of monitored values of the first optical detector and a third optical detector;
a second monitoring mechanism that takes a ratio of monitored values of the second optical detector and the third optical detector; and
a wavelength control mechanism that controls an oscillation wavelength of the tunable laser in such a manner that a ratio of a monitored value of the first monitoring mechanism and a monitored value of the second monitoring mechanism becomes a prescribed value.

16. The optical module according to claim 15, wherein
the wavelength control mechanism is a mechanism that heats a heater set on a waveguide that forms the waveguide wavelength-tunable filter.
